(19) United States
(12) Patent Application Publication
(10) Pub. No.: US 2005/0111512 A1
(43) Pub. Date: May 26, 2005

(54) Apparatus for generating and transmitting laser light

(76) Inventor: Martina Krieg, Berlin (DE)

Correspondence Address: Merchant & Gould P.C., P.O. Box 2903, Minneapolis, MN, 55402-0903, US

(21) Appl. No.: 10/941,675

(22) Filed: Sep. 15, 2004

(30) Foreign Application Priority Data
Sep. 17, 2003 (DE) 103 43 244.2

(51) Int. Cl. H01S 3/08

(52) U.S. Cl. 372/92; 372/102

(57) ABSTRACT

The invention relates to an apparatus (1) for generating and transmitting laser light beams (14), comprising a semiconductor layer structure (2), two light conducting fiber elements (10, 16) coupled at two sides of the semiconductor layer structure (2) to an active layer (3) comprised by the semiconductor layer structure (2) and made of a semiconductor material which is electrically excitable to generate light, and a laser resonator (7) with optical feedback means between which the active layer (3) is positioned, the laser resonator (7) including an optical grating to select laser light beams (14) of at least one predetermined laser wavelength. The optical grating is formed as a fiber grating (6) outside of the active layer (3) in a portion of one of the two light conducting fiber elements (10) comprised by the laser resonator (7).

The invention relates to the art of apparatus for generating and transmitting laser light beams, especially in combination with optical signal transmission.

Apparatus of the kind in question are used, for instance, in optoelectronic systems to transmit information by means of optical data signals. The laser light beams are generated by a semiconductor laser chip. The semiconductor laser chip typically comprises a semiconductor layer structure, including an active layer made of a semiconductor material which can be excited to generate fluorescence. The light thus obtained is reflected back and forth between terminal feedback means in a laser resonator. The light taking roundtrips in the laser resonator is amplified as it penetrates the active layer. When the light reflected back and forth in the laser resonator exceeds a threshold value in intensity, it is decoupled from the laser resonator to be passed on to further use, such as into an optical fiber element or a light guiding fiber, especially into fiber glass. The optical fiber element then may serve to transmit the laser light beams across long distances to other optical/electrooptical components. A known embodiment of a laser based on a semiconductor laser chip, for instance, is the so-called DFB laser (distributed feedback laser). The optical layer of this semiconductor laser is designed to selectively amplify only light of a certain wavelength. To accomplish that, part of the active layer is given a surface structure which acts as an optical grating.

Another known embodiment of an apparatus based on a semiconductor laser chip for generating laser light beams is referred to as FGL laser (fiber grating laser). With this laser, the light generated in the active layer is coupled into an optical fiber element (light conducting fiber) in which an optical fiber grating is formed to act as a wavelength selective element. The fiber grating in the fiber element represents a terminal feedback means of the laser resonator and, at the same time, acts to decouple the laser light beams from the laser resonator. With this design, another terminal feedback means of the laser resonator is embodied, for example, by a highly reflective coating on a facet of the active layer. Both the DFB laser and the FGL laser belong to the so-called single mode lasers serving to generate narrow bandwidth laser light beams.

It is an object of the invention to indicate an apparatus for generating laser light beams which apparatus is capable of providing laser light beams of improved quality.

The object is met, in accordance with the invention, by an apparatus for generating and transmitting laser light beams as recited in independent claim 1.

The invention embraces the concept of furnishing an apparatus for generating and transmitting laser light beams with a semiconductor layer structure and two light conducting fiber elements coupled at two sides of the semiconductor layer structure to an active layer comprised by the semiconductor layer structure and made of a semiconductor material suitable to be excited electrically in order to generate light. Moreover, the apparatus comprises a laser resonator with optical feedback means between which the active layer is positioned. The laser resonator includes an optical grating for selecting laser light beams of at least one predetermined wavelength. The optical grating is embodied by a fiber grating outside of the active layer in a portion of one of the two light conducting elements comprised by the laser resonator.

An advantage achieved by the invention over the prior art resides in the fact that the apparatus designed accordingly offers signal stability regardless of the decoupled optical performance. That permits the decoupled laser power to be adjusted to a predetermined value without compromising signal quality. With the proposed structural design and adequate dimensioning of the individual elements, moreover, better signal quality and, consequently, a better signal to noise ratio can be obtained along with higher output power.

In a convenient modification of the invention the active layer is a bent waveguide having a tilted facet opposite the one light conducting element in which the fiber grating is formed. This is a way of improving the quality of the wavelength selection in the laser resonator since undesirable back reflections are avoided at the ends of the active layer. Hereby the signal to noise ratio of the decoupled laser light radiation is further improved.

In a further development of the invention, the one light conducting element in which the fiber grating is formed is disposed at an angle with respect to an end portion of the active layer opposite the one light conducting element so that a wedge-shaped gap is formed between the entry surface of the one light conducting element and the tilted facet of the active layer, said gap being filled with material which is adapted to the effective refractive index of the one fiber element.

With a preferred embodiment of the invention, better coupling of the light reflected back from the fiber grating into the active layer is achieved in that the active layer is designed, at least in the range of the end portion opposite the one light conducting fiber element, such that the optical field is expanded. The result thereof is further increase in output power and optimized signal stability. With this embodiment undesired reflections are reduced at the boundary faces of the active layer and of the light conducting fiber element due to the filler material with its properly adapted refractive index.

In a convenient further development, an antireflection layer may be formed on the facet of the active layer opposite the one light conducting fiber element in which the fiber grating is located as this will reduce undesired reflections at this facet.

It may be advantageous, with a modification of the invention, for the fiber grating to have great reflecting power and for a facet of the active layer opposite the other one of the two light conducting fiber elements to be devised as the decoupling means of the laser resonator so that the laser light beams, being the signal output through the facet opposite the other light conducting fiber element, can be decoupled from the laser resonator into the other light conducting fiber element. In this manner the laser light radiation is decoupled through the facet at the other side of the active layer and into the light conducting fiber element.

A covenient embodiment of the invention offers a possibility, to be implemented at little expenditure, of monitoring the intensity of the laser light beams generated by the apparatus in that the fiber grating is embodied by a partly transmitting grating to decouple transmitted laser light rays for a monitoring means.

Unwanted reflections and to a certain extent coupling losses can be avoided, with a convenient further development of the invention, by coupling the other one of the light conducting fiber elements to the active layer through a material which is adapted to the effective refractive index of the other fiber element.

In an advantageous embodiment of the invention provision is made for a heater element to be arranged in the semiconductor layer structure adjacent the active layer. The heater element may be used to influence the temperature of the material of the active layer and/or the surrounding layers, whereby certain physical properties can be adjusted which in turn influence the parameters of the laser light beams generated.

The heater element preferably may be devised so that, selectively or simultaneously, it will also fulfill the function of a thermistor (depending on the electrical drive control). In this manner it will be capable not only of heating the active layer but also measuring the temperature thereof. Thus the heater strip (combined with large-area Peltier cooling, e.g. below the substrate on which the semiconductor layer structure is built) can be used as part of an efficient temperature control system. The compact nature of the structure is a substantial advantage in this respect. As the distance is small between the thermistor and the active layer, the temperature measured at any time is highly conform with the actual temperature in the active layer. That permits rapid and efficient temperature control.

The invention will be described further, by way of example, with reference to the accompanying drawing, in which:

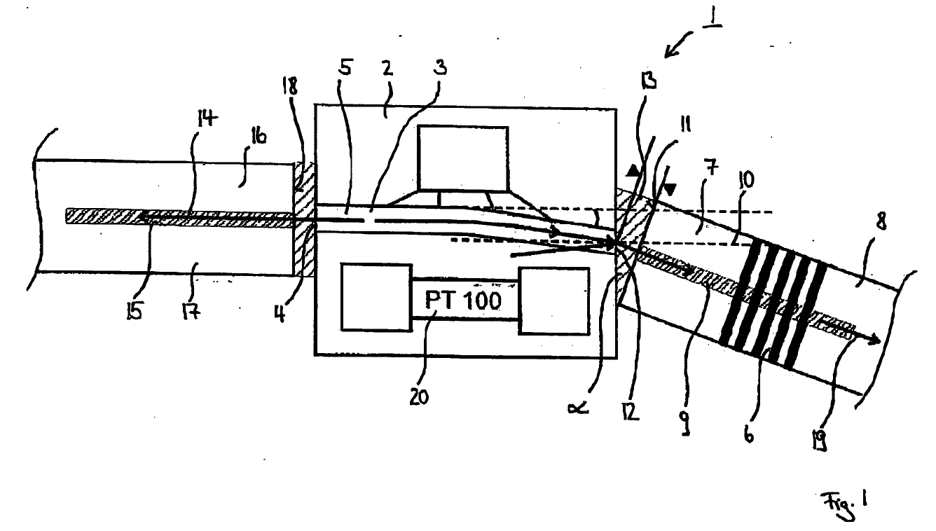

FIG. 1 shows an apparatus for generating and transmitting laser light beams, a fiber element being coupled to a tilted facet of an active layer; and

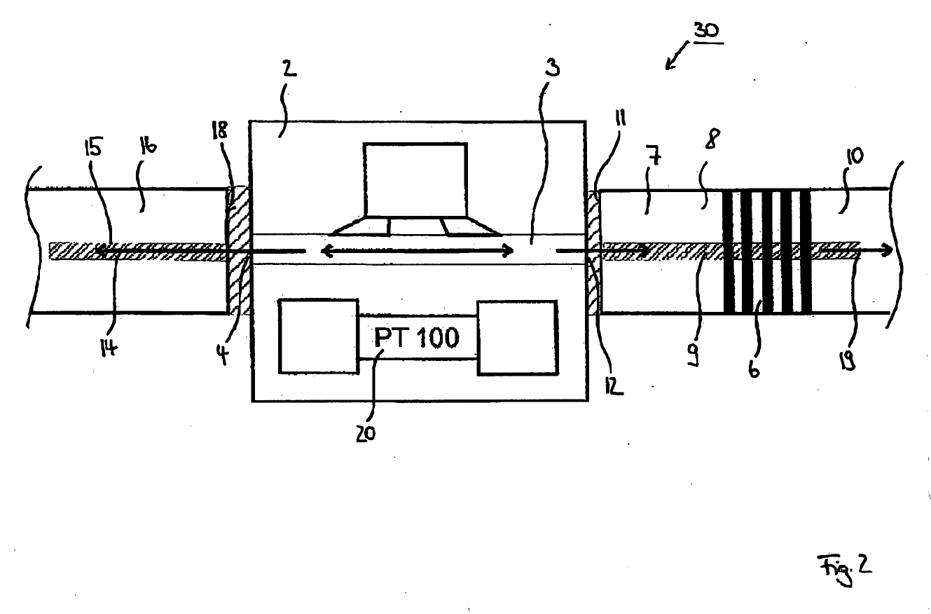

FIG. 2 shows another apparatus for generating and transmitting laser light beams, the active layer having straight facets at either side.

In FIG. 1 an apparatus 1 is shown for generating and transmitting laser light beams, comprising a semiconductor layer structure 2 in which an active layer 3 is formed as a bent waveguide. It is convenient for the semiconductor layer structure 2 to be devised as a laser chip in which light is generated in per se known manner in the active layer 3 by the supply of electrical energy. The light thus generated is reflected between a facet 4 at one end 5 of the active layer 3 and a fiber grating 6. The facet 4 and the fiber grating 6 present feedback means of a laser resonator 7. The fiber grating 6 is formed in a fiber element 8 which is a light conducting fiber having a light conducting core 9 and cladding 10. A front end face 11 of the fiber element 8 extends at an angle alpha with respect to another facet 12 of the active layer 3. The other facet 12 is a tilted facet. Material which is adapted to the effective refractive index of the fiber element 8 with its light conducting core 9 and cladding 10 fills a resulting gap 13 between the front end face 11 and the other facet 12.

Laser light radiation 14 decoupled from the laser resonator is coupled through the facet 4 into a light conducting core 15 of another fiber element 16. The light conducting core 15 of the other fiber element 16 is surrounded by a cladding 17. A Material which is adapted to the effective refractive index of the other fiber element 16 is disposed between a front end face 18 of the other fiber element 16 and the facet 4 to avoid light coupling losses and undesired reflections. This material may be a gel or fluid having an appropriate refractive index.

In the embodiment shown, the facet 4 is not coated so that the reflected intensity is approximately 30%. In this manner the facet 4 presents the feedback means of the laser resonator 7 and, at the same time, serves as decoupling means to decouple the laser light beams 14. The fiber grating 6 is embodied by a partly transmitting grating having great reflective capacity of 90%, for instance. Therefore, transmitting light beams 19 can be guided to a monitoring diode (not shown) to monitor and control the output power of the apparatus 1.

A heater strip 20 with simultaneous thermistor functionality is provided in the semiconductor layer structure 2, illustrated in FIG. 1, for regulation of temperature conditions in the semiconductor layer structure 2 in the vicinity of the active layer 3 to control parameters of the laser light.

FIG. 2 shows another apparatus 30 for generating and transmitting laser light beams. Other than in the apparatus according to FIG. 1, the active layer 3 is made straight and the fiber element 10 is disposed substantially parallel to the other fiber element 16, thereby presenting a simplified structure. With this embodiment, too, both fiber elements 10, 16 are coupled to the active layer 3 through a material adapted to the effective refractive index of the respective light conducting fiber element, for example, through a gel having an adapted refractive index.

The features disclosed in the specification above, in the claims and drawing my be significant for implementing the invention in its various embodiments, both individually and in any combination.

1. An apparatus for generating and transmitting laser light beams, comprising a semiconductor layer structure (2), two light conducting fiber elements (10, 16) coupled at two sides of the semiconductor layer structure (2) to an active layer (3) comprised by the semiconductor layer structure (2) and made of a semiconductor material which is electrically excitable to generate light, and a laser resonator (7) with optical feedback means between which the active layer (3) is positioned, the laser resonator (7) including an optical grating to select laser light beams of at least one predetermined laser wavelength, characterized in that the optical grating is embodied by a fiber grating (6) outside of the active layer (3) in a portion of one of the two light conducting fiber elements (10) comprised by the laser resonator (7).

2. The apparatus as claimed in claim 1, characterized in that the active layer (3) is a bent waveguide having a tilted facet (12) opposite the one light conducting element (10) in which the fiber grating (6) is formed.

3. The apparatus as claimed in claim 2, characterized in that the one light conducting fiber element (10) in which the fiber grating (6) is formed is disposed at an angle with respect to an end portion of the active layer (3) opposite the one light conducting fiber element (10) so that a wedge-shaped gap is formed between the entry surface (11) of the one light conducting element (10) and the tilted facet (12) of the active layer (3), said gap being filled with a material which is adapted to the effective refractive index of the one fiber element (10).

4. The apparatus as claimed in claim 3, characterized in that, at least in the range of the end portion opposite the one light conducting fiber element (10), the active layer (3) is designed so as to expand the optical field.

5. The apparatus as claimed in claim 1, characterized in that an antireflection layer is formed on the facet (12) of the active layer (3) opposite the one light conducting fiber element (10) in which the fiber grating (6) is formed.

6. The apparatus as claimed in claim 1, characterized in that the fiber grating (6) has great reflecting power, and a facet (4) of the active layer (3) opposite the other one of the light conducting fiber elements (16) is designed to be the decoupling means of the laser resonator so that the laser light beams (14), being the signal output through the facet (4), can be decoupled from the laser resonator (7) through the facet (4) opposite the other light conducting element (16) and into the same.

7. The apparatus as claimed in claim 6, characterized in that the fiber grating (6) is a partly transmitting grating to decouple transmitted laser light beams (19) for a monitor means.

8. The apparatus as claimed in claim 1, characterized in that the other one of the light conducting fiber elements (16) is coupled to the active layer (3) via a material adapted to the effective refractive index of the other fiber element (16).

9. An arrangement as claimed in claim 1, characterized in that a heater element (20) is arranged in the semiconductor layer structure (2) adjacent the active layer (3).

10. The arrangement as claimed in claim 9, characterized in that the heater element (20) is a thermistor.
